(19) United States
(12) Patent Application Publication
(10) Pub. No.: US 2025/0209861 A1
(43) Pub. Date: Jun. 26, 2025

(54) VEHICLE IDENTITY DETERMINATION BASED ON VEHICLE COMPUTER RESPONSE ADDRESS

(71) Applicant: Innova Electronics Corporation, Irvine, CA (US)

(72) Inventors: Keith Andreasen, Garden Grove, CA (US); Thanh Phan, Tan Binh District (VT)

(21) Appl. No.: 18/390,208

(22) Filed: Dec. 20, 2023

(51) Int. Cl. G07C 5/00

(52) U.S. Cl. CPC G07C 5/008

(57) ABSTRACT

A method of determining an identity of an electric vehicle includes sending an initialization command from a data acquisition and transfer device (DAT) to a vehicle computer via a diagnostic port on the vehicle, and receiving, at the DAT, an initial response signal from the vehicle computer via the diagnostic port. The initial response signal includes a list of response addresses associated with respective systems on the vehicle. The list of response addresses included in the initial response signal is compared to a response address database having lists of response addresses matched with vehicle identification information to determine vehicle identification information of the vehicle. A configuration database having configuration instructions matched with vehicle identification information is accessed, with the configuration instructions being associated with a vehicle-specific tool functionality. The DAT is configured to implement the vehicle-specific tool functionality based on the determined vehicle identification information of the vehicle.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to retrieval of vehicle identification information from a vehicle, and more specifically to obtaining an electronic vehicle identification number from an electronic vehicle.

### 2. Description of the Related Art

The integration of computers into vehicles has resulted in an increase in the amount of digital data available for vehicle diagnostics. As such, many vehicle diagnostic tools are configured to communicate with a vehicle for purposes of retrieving data from the vehicle, with the data providing valuable insight into the operational health of the vehicle. In order to retrieve the data and implement various diagnostic functionalities, the electrical systems on the vehicle may require communication in vehicle-specific communication protocols. Furthermore, various commands, tests, diagnostic parameters, etc. may vary from vehicle to vehicle. Thus, identification of the vehicle may be a crucial step in the diagnostic process.

For many vehicles using internal combustion engines, particularly vehicles that are model years newer than 1996, the vehicle identity can be readily ascertained in response to generally universal response requests. Thus, when a conventional diagnostic tool makes a generally universal request for the electronic vehicle identification number (VIN) to a newer internal combustion engine, most vehicles can quickly provide that information to the diagnostic tool.

However, an electric vehicle may not provide an electronic VIN in response to such a standard, general request. Rather, the electrical systems on electric vehicles may be unique to the OEM, and thus, retrieving an electronic VIN from an electric vehicle may require an OEM specific protocol or procedure.

Accordingly, there is a need in the art for easily retrieving vehicle identification information to facilitate vehicle-specific diagnostics. Various aspects of the present disclosure address this particular need, as will be discussed in more detail below.

### BRIEF SUMMARY

Various embodiments of the present disclosure are directed toward systems and methods of determining an identity of an electric vehicle based on communications received from the vehicle. In more detail, the identity of the vehicle may be determined based on analyzing a data packet from the vehicle, wherein the data packet may not include direct vehicle identifying information therein. However, the data packet may include unique characteristics, similar to a digital fingerprint, that may be analyzed to determine vehicle identification characteristics, such as the make, manufacturer or OEM of the vehicle.

According to one embodiment, there is provided a method of determining an identity of an electric vehicle. The method includes sending an initialization command from a data acquisition and transfer device (DAT) to a vehicle computer via a diagnostic port on the vehicle, and receiving, at the DAT, an initial response signal from the vehicle computer via the diagnostic port. The initial response signal includes a list of response addresses associated with respective systems on the vehicle. The list of response addresses included in the initial response signal is compared to a response address database having lists of response addresses matched with vehicle identification information to determine vehicle identification information of the vehicle. A configuration database having configuration instructions matched with vehicle identification information is accessed, with the configuration instructions being associated with a vehicle-specific tool functionality. The DAT is configured to implement the vehicle-specific tool functionality based on the determined vehicle identification information of the vehicle.

The vehicle identification information may include the make or manufacturer of the vehicle.

The configuring step may include identifying an electronic control unit (ECU) to send a request for a vehicle identification number (VIN) of the vehicle. The method may also include sending a request to the identified ECU for the VIN of the vehicle. The identified ECU may be an ECU not implementing the functionalities of a powertrain control module and/or the transmission control module. In an alternative embodiment, the ECU including the VIN may be a powertrain control module or a transmission control module, or another control module including the VIN.

The vehicle-specific tool functionality may include implementing a vehicle-specific communication protocol to facilitate communication with the vehicle. The vehicle-specific tool functionality may include generating a vehicle-specific test command for communication to the vehicle.

The initialization command may be OBD-II “01 00,” or may be another initialization command, such as “02 3E.”

According to another embodiment, there is provided a method of determining an identity of an electric vehicle. The method includes sending an initialization command from a data acquisition and transfer device (DAT) to a vehicle computer via a diagnostic port on the vehicle. The method further includes receiving, at the DAT, an initial response signal from the vehicle computer via the diagnostic port, with the initial response signal being devoid of vehicle identification information and including a list of response addresses associated with respective systems on the vehicle. The list of response addresses included in the initial response signal is compared to a response address database having lists of response addresses matched with vehicle identification information to determine vehicle identification information of the vehicle. The DAT is configured to implement the vehicle-specific tool functionality based on the determined vehicle identification information of the vehicle.

According to yet a further environment, there is provided a vehicle diagnostic device including a housing and a memory circuit located within the housing. The memory circuit includes a response address database having lists of response addresses matched with vehicle identification information, and a configuration database having configuration instructions matched with vehicle identification information. The configuration instructions are associated with a vehicle-specific tool functionality. The vehicle diagnostic device further includes a processor located within the housing and in operative communication with the memory circuit. The processor is configured to generate an initialization command for transmission to a vehicle computer via a diagnostic port on the vehicle and receive an initial response signal from the vehicle computer via the diagnostic port. The initial response signal includes a list of response addresses associated with respective systems on the vehicle. The processor is further configured to access the response address database to compare the list of response addresses included in the initial response signal to the lists of addresses in the response address database to determine vehicle identification information of the vehicle. The processor is further configured to access the configuration database to configure the DAT to implement the vehicle-specific tool functionality based on the determined vehicle identification information of the vehicle.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic overview of a system for determining a vehicle identification characteristic of an electric vehicle;

FIG. 2 is a schematic overview of various signals that are transmitted while determining the vehicle identification characteristic of an electric vehicle; and

FIG. 3 is a flow chart depicting possible response signals from the vehicle responsive to one or more initialization signals.

Common reference numerals are used throughout the drawings and the detailed description to indicate the same elements.

### DETAILED DESCRIPTION

The detailed description set forth below in connection with the appended drawings is intended as a description of certain embodiments of a system and method for determining a vehicle identification characteristic of an electrical vehicle and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to a system and related methodology of retrieving a vehicle identification number (VIN) on an electric vehicle. In this regard, the process of obtaining the VIN on an electric vehicle may differ from that of an internal combustion engine. The identification of the VIN on an electric vehicle may be based on an analysis of an original data packet returned from the vehicle. The characteristics of the original data packet may serve as a digital fingerprint, which may allow for identification of the original equipment manufacturer (OEM) of the vehicle. Once the OEM is known, a particular vehicle electronic control unit (ECU) capable of providing the VIN may be identified and communication with that ECU may be established to retrieve the VIN. Various implementations of the systems and methods described herein may be capable of determining the VIN on an electric vehicle as well as an internal combustion engine vehicle, and thus, features of the present disclosure may enable universal use across a wide range of vehicles.

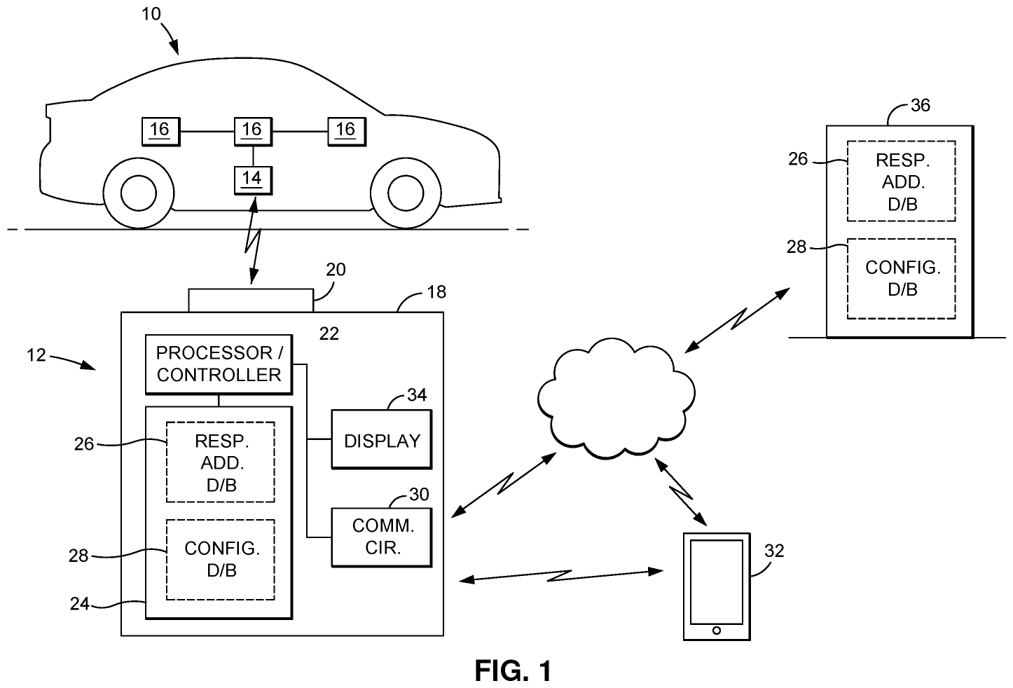

Referring now to FIG. 1, there is depicted a schematic overview including an electric vehicle 10 and a data acquisition and transfer device (DAT) 12 configured to communicate with the electric vehicle 10. As used herein, the term electric vehicle may refer broadly to any vehicle that is not powered by an internal combustion engine. An example of an electric vehicle manufacturer is TESLA™, although those skilled in the art will understand that other vehicle manufacturers make electric vehicles 10. Along these lines, certain manufacturers may produce electric vehicles exclusively, while other manufacturers may produce both electric vehicles 10 as well as internal combustion engine vehicles.

The electric vehicle 10 includes a diagnostic port 14 which may be configured to facilitate electrical communications between an electronic network on the vehicle and the DAT 12. The electronic network may include several electronic control units (ECUs) 16, as well as electronic control modules, electrical sensors, components, etc., on the vehicle 10.

The DAT 12 may include a housing 18 and a connector 20 coupled to the housing 18 and sized to be operatively engageable with the diagnostic port 14 on the vehicle 10. The operative engagement between the DAT 12 and the diagnostic port 14 may be via plug-connection between the connector 20 and the diagnostic port 14, although it is contemplated that wireless communication between the DAT 12 and the diagnostic port 14 may exist without departing from the spirit and scope of the present disclosure. The housing 18 may be hand-holdable to facilitate easy transport and use of the DAT 12. In this regard, the size of the housing 18 may be similar to a conventional scan tool, code reader, smartphone, tablet computer, etc. However, the housing 18 may also be larger, such as the size of a desktop computer or other more sizeable diagnostic equipment/hardware without departing from the spirit and scope of the present disclosure.

The DAT 12 may include an internal processor/controller 22 configured to facilitate implementation of various functionalities described herein. Furthermore, the DAT 12 may include a memory circuit 24 having one or more databases 26, 28 stored thereon. It is also contemplated that the DAT 12 may include a communication circuit 30 to facilitate communication with remote devices and resources, as may be needed to implement certain desired functionalities. The communication circuit 30 may utilize Bluetooth™, WiFi™ cellular, or other forms of communication. The communication capabilities of the DAT 12 may allow the DAT 12 to communicate with a user's smartphone 32, computer or other communication device. The DAT 12 may optionally include a local display 34 for displaying diagnostic results or other content to the user.

The process of determining an identity of the electric vehicle 10 may start by connecting the DAT 12 to the diagnostic port 14 on the vehicle 10. The DAT 12 may be configured to receive power from the vehicle 10 in response to connection of the DAT 12 to the diagnostic port 14. Alternatively, the DAT 12 may include a local power source to power to the DAT 12.

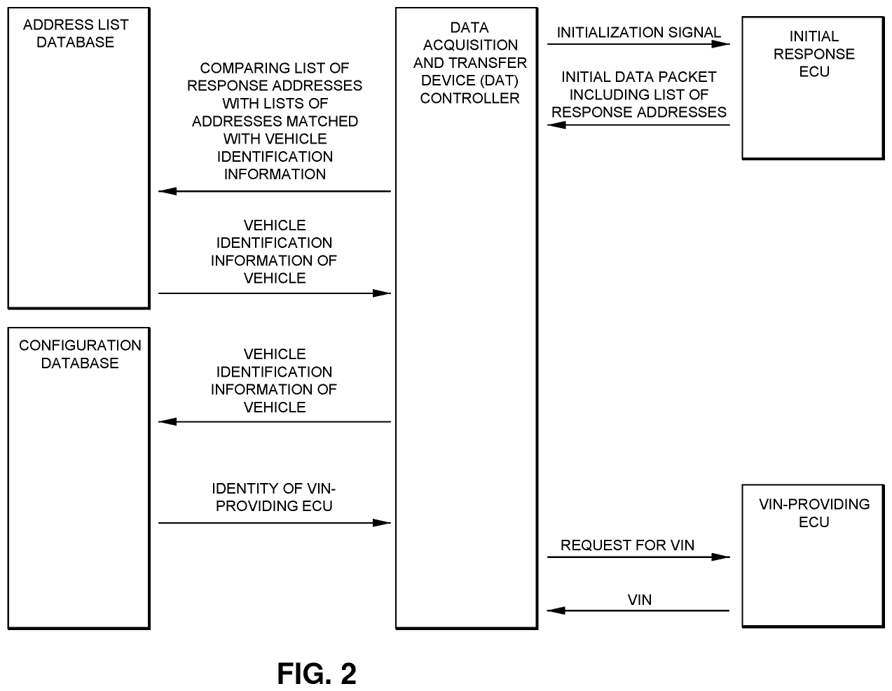

Once the DAT 12 is connected to the diagnostic port 14, the DAT 12 may send an initialization command/signal to a vehicle computer/ECU 16 via the diagnostic port 14 on the vehicle 10. FIG. 2 is a schematic overview depicting signals transmitted during one exemplary implementation of the associated methodology, with the sequence of signal transmission being associated with the vertical positioning of the representative arrows included in FIG. 2. The initialization command may be a command used by the DAT 12 in connection with both internal combustion engine vehicles as well as electric vehicles. In the case of internal combustion engine vehicles, receipt of the initialization command by the internal combustion engine vehicles from the DAT 12 may prompt the internal combustion engine vehicles to return a data signal to the that includes the electronic VIN. However, receipt of the initialization signal by electric vehicles 10 generally does not result in electric vehicles 10 returning a signal including the electronic VIN. Instead, electric vehicles 10 typically return a data packet which may identify responsive ECUs 16 on the vehicle 10. In some instances, the return data packet may include a list of addresses of the responsive ECUs 16 on the vehicle 10.

In one embodiment, the initialization command may be OBD-II “01 00,” although other initialization commands may be used without departing from the spirit and scope of the present disclosure. For instance, command “02 3E” may be used, along with other commands.

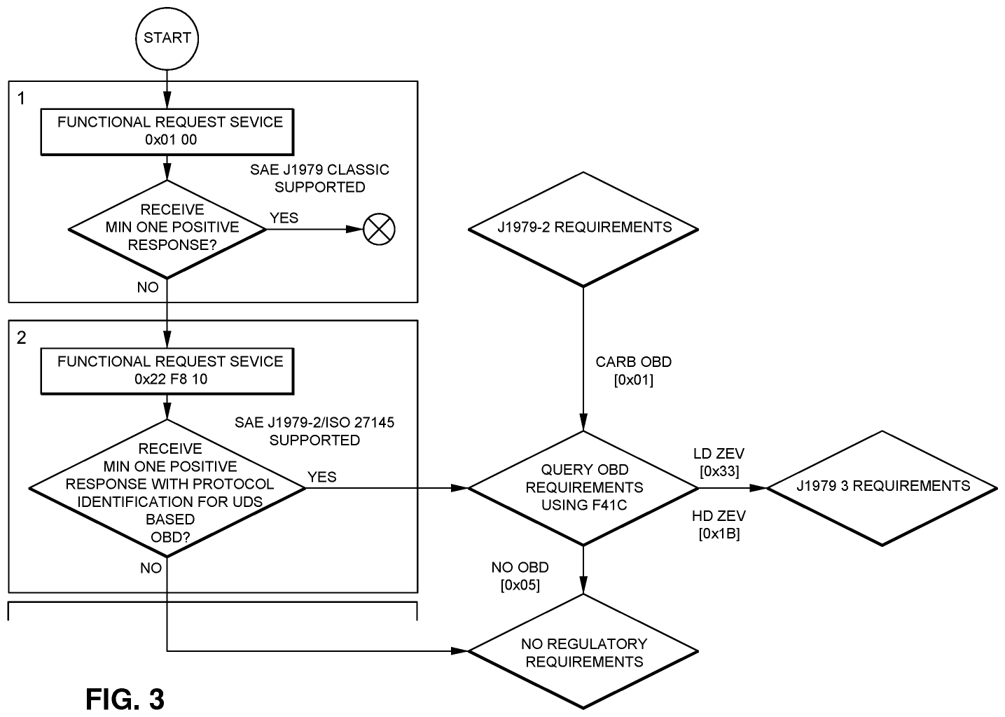

FIG. 3 provides a flowchart of possible return signals from the vehicle in response to receiving a “SID 01 00” request. In a first scenario, a positive response is received and a list of addresses providing a response to the command request “SID 01 00” is collected or compiled. That list may be used later for comparison to similar lists stored in a response address database 26 to identify vehicle identity characteristics, as will be described in more detail below. In a second scenario, no response is received in response to the “SID 01 00” request, and in such cases, a request service “SID 22 F8 10” for SAI J1979-2 may be sent or command keep alive “02 3E” may be sent.

The DAT 12 may receive the initial response signal and the content in the response signal may be compared to information in a response address database 26 having vehicle identification information matched with lists of response addresses. For instance, when the initial response signal includes a list of response addresses included, the list from the initial response signal may be compared to a response address database having lists of response addresses matched with vehicle identification information to determine vehicle identification information (e.g., the make, manufacturer, or OEM of the vehicle) of the vehicle 10. The response address database 26 may be located locally on the memory circuit 24 of the DAT 12, or may be on a server 36 or device remote from the DAT 12. When the response address database 26 is remote from the DAT 12, the DAT 12 may upload the list to the device 36 on which the response address database 26 is located to identify the vehicle identification information of the vehicle 10.

The chart below provides examples of response address lists for two different vehicles associated with two different OEMs.

| OEM 1 | OEM 2 |
|---|---|
| $7E7 Battery Energy Control Module | $7EE/7E6 Active Air Flap |
| $7E6 Brake Booster Control Module | $7EC Battery Management System |
| $7E3 Chassis Control Module | $7EA/7E2 VCU LDC => Call SID |
| | 1A => $0080 VIN |
| $7E0 Engine Control Module => | $7EB/7E3 Motor Control Unit |
| SID 22 VIN DID $0090 | |
| | $7ED/7E5 On-board Charger |

The response address database 26 may be located locally on the memory circuit 24 of the DAT 12, or may be on a server 36 or device remote from the DAT 12. When the response address database 26 is remote from the DAT 12, the DAT 12 may upload the list to the device on which the response address database 26 is located to identify the vehicle identification information of the vehicle 10.

Once the make, manufacturer, or OEM of the vehicle 10 is identified, a configuration database 28 may be accessed to configure the DAT 12 to implement a vehicle-specific tool functionality. The configuration database 28 may include configuration instructions matched with vehicle identification information. Thus, once the vehicle identification information is known, the configuration instructions associated with the particular vehicle to which the DAT 12 is connected may be identified and executed by the DAT 12.

In one embodiment, the configuring step may include identifying a particular ECU 16 to send a request for the electronic VIN of the vehicle 10. In this regard, it is understood that many electric vehicles 10 may be capable of providing an electronic VIN in response to a request; however, knowledge of the particular vehicle ECU 16 that provides the VIN may be required to allow the DAT 12 to generate the request to the specific ECU 16. In many electric vehicles, the ECU 16 capable of providing the electronic VIN is an ECU 16 other than the power-train control module and the transmission control module. Once the particular ECU 16 having the VIN is known, the DAT 12 may send a request to that ECU 16 for the VIN.

It is contemplated that the vehicle-specific tool functionality may include functionality other than identifying the particular vehicle ECU 16 that provides the VIN. For instance, the functionality may include implementing a vehicle-specific communication protocol to facilitate communication with the vehicle 10. It is also contemplated that the vehicle-specific tool functionality may include generating a vehicle-specific test command for communication to the vehicle 10. The vehicle-specific tool functionality may further include identifying vehicle-specific diagnostic resources, such as historical database, a diagnostic algorithm, or determining a vehicle-battery state of health, etc. For more information regarding the determination of vehicle-battery state of health, please refer to U.S. patent application Ser. No. 18/137,753 entitled HIGH VOLTAGE BATTERY STATE OF HEALTH, filed Apr. 21, 2023, the contents of which are expressly incorporated herein by reference.

It is contemplated that various aspects of the present disclosure may be implemented autonomously in response to a prescribed trigger event, so as to minimize interaction or input from a user. The ability to implement various functionalities autonomously may allow for a more user-friendly experience, and may also minimize user error. For instance, in one embodiment, the determination of vehicle identification information may be made in response to facilitating an operative connection between the DAT 12 and the vehicle. It is contemplated that the operative connection may be implemented by plugging the DAT 12 into the vehicle or wirelessly linking the DAT 12 to the vehicle. Thus, all intervening steps between connecting the DAT 12 to the vehicle and determining the vehicle identification information may be performed autonomously in response to operatively connecting the DAT 12 to the vehicle. In another embodiment, the autonomous capabilities may further include configuring the DAT 12 to implement the vehicle-specific tool functionality. Such configuration may be implemented in response to operatively connecting the DAT 12 to the vehicle, in which case all intervening steps are performed autonomously in response to connection of the DAT 12 to the vehicle. In another embodiment, fewer steps may be performed autonomously. For instance, the determination of the vehicle identification information may be performed autonomously in response to receipt of an initial response signal from the vehicle. Thus, various implementations of the present disclosure may allow for any number of steps to be implemented autonomously in response to a trigger event.

It is also contemplated that various embodiments of the present disclosure may utilize one or more machine learning models to identify vehicle identification information and/or identify vehicle-specific functionalities. In this regard, a controller/processor in the DAT 12 or a remote device (e.g., smartphone, server, etc.) may apply the machine learning model to an initial response signal, with the output of the machine learning model being the vehicle identification information and/or configuration information for the DAT 12. Such a machine learning model may be trained using historical initial response signals and historical vehicle identification information and/or configuration information for the DAT 12. By training a machine learning model with this kind of training data, the machine learning model may recognize, for a given initial response signal, the correct vehicle identification information and/or configuration instructions for the DAT 12.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method of determining an identity of an electric vehicle, the method comprising the steps of:
sending an initialization command from a data acquisition and transfer device (DAT) to a vehicle computer via a diagnostic port on the vehicle;
receiving, at the DAT, an initial response signal from the vehicle computer via the diagnostic port, the initial response signal including a list of response addresses associated with respective systems on the vehicle;
comparing the list of response addresses included in the initial response signal to a response address database having lists of response addresses matched with vehicle identification information to determine vehicle identification information of the vehicle;
accessing a configuration database having configuration instructions matched with vehicle identification information, the configuration instructions being associated with a vehicle-specific tool functionality; and
configuring the DAT to implement the vehicle-specific tool functionality based on the determined vehicle identification information of the vehicle.

2. The method recited in claim 1, wherein the vehicle identification information is the make of the vehicle.

3. The method recited in claim 1, wherein the vehicle identification information is the manufacturer of the vehicle.

4. The method recited in claim 1, wherein the configuring step includes identifying an electronic control unit (ECU) to send a request for a vehicle identification number (VIN) of the vehicle.

5. The method recited in claim 4, further comprising the step of sending a request to the identified ECU for the VIN of the vehicle.

6. The method recited in claim 5, wherein the identified ECU is an ECU not implementing the functionalities of a powertrain control module and the transmission control module.

7. The method recited in claim 1, wherein the vehicle-specific tool functionality includes implementing a vehicle-specific communication protocol to facilitate communication with the vehicle.

8. The method recited in claim 1, wherein the vehicle-specific tool functionality includes generating a vehicle-specific test command for communication to the vehicle.

9. The method recited in claim 1, wherein the initialization command is OBD-II “01 00.”

10. A method of determining an identity of an electric vehicle, the method comprising the steps of:
sending an initialization command from a data acquisition and transfer device (DAT) to a vehicle computer via a diagnostic port on the vehicle;
receiving, at the DAT, an initial response signal from the vehicle computer via the diagnostic port, the initial response signal being devoid of vehicle identification information and including a list of response addresses associated with respective systems on the vehicle;
comparing the list of response addresses included in the initial response signal to a response address database having lists of response addresses matched with vehicle identification information to determine vehicle identification information of the vehicle; and
configuring the DAT to implement the vehicle-specific tool functionality based on the determined vehicle identification information of the vehicle.

11. The method recited in claim 10, further comprising the step of accessing a configuration database having configuration instructions matched with vehicle identification information, the configuration instructions being associated with a vehicle-specific tool functionality.

12. The method recited in claim 10, wherein the vehicle identification information is the make of the vehicle.

13. The method recited in claim 10, wherein the vehicle identification information is the manufacturer of the vehicle.

14. The method recited in claim 10, wherein the configuring step includes identifying an electronic control unit (ECU) to send a request for a vehicle identification number (VIN) of the vehicle.

15. The method recited in claim 14, further comprising the step of sending a request to the identified ECU for the VIN of the vehicle.

16. The method recited in claim 15, wherein the identified ECU is an ECU not implementing the functionalities of a powertrain control module and the transmission control module.

17. The method recited in claim 10, wherein the vehicle-specific tool functionality includes implementing a vehicle-specific communication protocol to facilitate communication with the vehicle.

18. The method recited in claim 10, wherein the vehicle-specific tool functionality includes generating a vehicle-specific test command for communication to the vehicle.

19. The method recited in claim 10, wherein the initialization command is OBD-II “01 00.”

20. A vehicle diagnostic device comprising:
a housing;
a memory circuit located within the housing and having:
a response address database having lists of response addresses matched with vehicle identification information;
a configuration database having configuration instructions matched with vehicle identification information, the configuration instructions being associated with a vehicle-specific tool functionality;
a processor located within the housing and in operative communication with the memory circuit, the processor being configured to:
generate an initialization command for transmission to a vehicle computer via a diagnostic port on the vehicle;
receive an initial response signal from the vehicle computer via the diagnostic port, the initial response signal including a list of response addresses associated with respective systems on the vehicle;
access the response address database to compare the list of response addresses included in the initial response signal to the lists of addresses in the response address database to determine vehicle identification information of the vehicle; and
access the configuration database to configure the DAT to implement the vehicle-specific tool functionality based on the determined vehicle identification information of the vehicle.

21. The vehicle diagnostic device recited in claim 20, wherein the vehicle-specific tool functionality includes identifying an electronic control unit (ECU) to send a request for a vehicle identification number (VIN) of the vehicle.
